(19) United States
(12) Patent Application Publication
(10) Pub. No.: US 2003/0093816 A1
(43) Pub. Date: May 15, 2003

(54) Storage medium adaptable to changes in screen aspect ratio and reproducing method thereof

(75) Inventors: Hyun-Kwon Chung, Gyeonggi-do (KR); Kil-soo Jung, Gyeonggi-do (KR); Byung-jun Kim, Gyeonggi-do (JP)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-City (KR)

(21) Appl. No.: 10/280,127

(22) Filed: Oct. 25, 2002

(30) Foreign Application Priority Data
Oct. 25, 2001 (KR) 2001-66015
Mar. 11, 2002 (KR) 2002-12978

(51) Int. Cl. H04N 9/79; H04N 11/04; H04N 1/00; H04N 7/16

(52) U.S. Cl. 725/142; 725/141; 386/40; 386/124

(57) ABSTRACT

A storage medium adaptable to changes in a screen aspect ratio provides various information and audio/video contents that are displayable in a user interactive environment, and includes interactive screen display files that correspond to different screen aspect ratios, respectively. The interactive screen display files are constituted to be adjusted to corresponding screen aspect ratios. Interactive information in the storage medium is constituted to be adjusted to different screen aspect ratios. Thus, interactive information can be displayed without distorting the position and size thereof even when a screen of a predetermined size is changed into another screen of a different size.

### CROSS-REFERENCE TO RELATED APPLICATIONS

This application is based upon and claims priority from Korean Patent Application Nos. 2001-66015 and 2002-12978 respectively filed Oct. 25, 2001 and Mar. 11, 2002 in the Korean Intellectual Property Office, the contents of which are incorporated herein by reference.

### BACKGROUND OF THE INVENTION

1. Field of the Invention

The present invention relates to a storage medium which is encoded with instructions for displaying an interactive screen, and a reproduction method thereof, and more particularly, to a storage medium which has interactive file structures that are adaptable to different screen aspect ratios, respectively, and a reproduction method thereof.

2. Description of the Related Art

In general, a storage medium records audio/video (A/V) contents and user-defined information. A/V contents refer to contents that are substantially provided by the storage medium, and the user-defined information refers to specific information that is prescribed by a producer. The A/V contents of the storage medium are reproduced by a stationary reproducing apparatus, and the user-defined information may be accessed by a computer and the like.

Recently, a storage medium has been introduced that is operable in a web-based environment consisting of hypertext markup language (HTML) and enables a user-interactive display including network links. The storage medium is called a “storage medium.” When reproducing the storage medium, a user can see an interactive screen that displays tools, texts, or images that have basic AN contents, and also allows the user to link to a network and search the network.

FIGS. 1A through 1D show the types of screens displayable when reproducing the storage medium. FIG. 1A shows an example of a screen having a 4:3 aspect ratio (hereinafter referred to as “4:3N”). FIG. 1B shows an example of a 4:3 letter-box screen (hereinafter referred to as “4:3L”), where parts with slanted lines are created at the top and bottom of the screen by applying 16:9 screen information to the screen. FIG. 1C shows an example of a 4:3 pan-scan screen, which is created to overcome a disadvantage that a letterbox screen is displayed too small. FIG. 1D shows an example of a 16:9 screen (hereinafter referred to as “16:9W”).

When 16:9 screen information is applied to a 4:3 screen, information of both sides of the screen that is relatively less important is cut out, resulting in the 4:3 pan screen shown in FIG. 1C. There is a great difference in the aesthetics of an image according to an editor's skill when displaying an image on a screen using this method.

A conventional storage medium is only reproduced on one of the screens shown in FIGS. 1A through 1D. In this case, when an HTML file suitable for any one of the screens in the storage medium is displayed on another screen having a different screen aspect ratio, the displayed data, such as text or graphics, are partially distorted. For instance, FIGS. 2A and 2B show examples of the distortion when a storage medium having an HTML file designed to be displayed on the 16:9W screen is instead displayed on the 4:3L screen. FIG. 2A shows information displayed on the 16:9W screen, and FIG. 2B shows the information of FIG. 2A when displayed on the 4:3L screen instead of the 16:9W screen. In FIG. 2B, the video data is shrunk, and the text or graphics created by the HTML file and the like are partially mislocated, which results in the distortion of the 4:3L screen. In some cases such as that shown in FIG. 2B, a portion of the texts or graphics overlapping the black areas of a screen may not show.

As described above, in the conventional storage medium and an apparatus and a method for reproducing the same, when a screen display mode is changed from one screen to another screen display, a distortion of displayed data occurs. As a result, a storage medium and a reproducing method thereof are necessary to fix the distortion of the position and size of data to be displayed when a screen display mode is changed from one screen to another screen display mode during reproduction.

### SUMMARY OF THE INVENTION

To solve the above and other problems, it is an object of the present invention to provide a storage medium and a reproducing method thereof that are adaptable to changes in an aspect ratio of a screen to display interactive data without distorting the interactive data.

Additional objects and advantages of the invention will be set forth in part in the description which follows and, in part, will be obvious from the description, or may be learned by practice of the invention.

Accordingly, to achieve the above and other objects, there is provided a storage medium according to an embodiment of the invention which provides various information and associated audio/video contents that are displayable in a user interactive environment, the storage medium including interactive screen display files, each of the interactive screen display files corresponding to one of a plurality of different screen aspect ratios, and each of the interactive screen display files are adjusted to the corresponding one screen aspect ratio.

According to an aspect of the invention, the interactive screen display files comprise interactive screen display files that are respectively displayable in a 16:9 screen, a 4:3 screen, a 4:3 letter-box screen, and a 4:3 pan-scan screen.

According to another aspect of the invention, the interactive screen display files comprise corresponding markup language-based document files.

According to another embodiment of the invention, a storage medium providing various information and audio/video contents that are displayable in a user interactive environment includes a screen information file and directories, where the screen information file provides interactive screen information including displayable screen aspect ratio information for a plurality of screen aspect ratios, each of the directories corresponding to one of the plurality of screen aspect ratios, and one directory is searched from the directories when reproducing the storage medium, a screen display file is read from the searched directory, and an interactive screen is created which is suitable for display on a screen with a corresponding screen aspect ratio from the read screen display file.

According to an aspect of the invention, the directories comprise directories corresponding to a 16:9 screen, a 4:3 screen, a 4:3 letter-box screen, and a 4:3 pan-scan screen, respectively.

According to another aspect of the invention, the screen display files comprise markup language-based document files.

According to yet another aspect of the invention, screen display files in the directories have the same file name.

According to a further embodiment of the invention, a storage medium providing various information and audio/video contents that are displayable in a user interactive environment includes different screen aspect ratio files, where a screen aspect ratio file predetermined for a reproducer is searched from the screen aspect ratio files to create an interactive screen that is suitable for a screen aspect ratio corresponding to the searched screen aspect ratio.

According to an aspect of the invention, the files comprise files corresponding to a 16:9 screen, a 4:3 screen, a 4:3 letter-box screen, and a 4:3 pan-scan screen, respectively.

According to another aspect of the invention, the files comprise markup language-based document files.

According to yet another aspect of the invention, each of the files include link tags linked to others of the files so that a screen aspect ratio mode being displayed is changeable to another screen aspect ratio mode.

According to an additional embodiment of the invention, a storage medium providing various information and audio/video contents that are displayable in a user interactive environment includes directories, each of the directories having data for one of a plurality of different screen aspect ratios, where, when reproducing, a directory having data corresponding to a screen aspect ratio predetermined for a reproducer is searched from the directories, a screen display file is read from the searched directory, and an interactive screen is created suitable for the corresponding aspect ratio from the data of the read screen display file.

According to an aspect of the invention, the directories comprise directories corresponding to a 16:9 screen, a 4:3 screen, a 4:3 letter-box screen, and a 4:3 pan-scan screen, respectively.

According to another aspect of the invention, the screen display files comprise markup language-based document files.

According to still another aspect of the invention, the screen display files in the directories have a common file name.

According to yet another embodiment of the invention, a storage medium providing various information and audio/video contents that are displayable in a user interactive environment includes a screen information file which provides interactive screen information including displayable screen aspect ratio information for a plurality of different screen aspect ratios, and files, with each file having data for a corresponding one of the plurality of different screen aspect ratios, where one of the files is searched from the files designated in the screen information file when reproducing the storage medium and an interactive screen is created suitable for the corresponding screen aspect ratio from the searched file.

According to an aspect of the invention, the files comprise a 16:9 screen, a 4:3 screen, a 4:3 letter-box screen, and a 4:3 pan-scan screen, respectively.

According to another aspect of the invention, the files comprise markup language-based document files.

According to yet another aspect of the invention, each of the files include link tags linked to the others of the files so that a screen aspect ratio mode being displayed is changeable to another screen aspect ratio mode.

According to a yet further embodiment of the invention, a method of reproducing a storage medium including screen display files which realize interactive environments so as to be adjusted to various screen sizes, where a display screen aspect ratio set in a reproducer is read, a corresponding screen display file having the screen aspect ratio is read from the storage medium, and an interactive screen is displayed based on the screen display file.

According to an aspect of the invention, the reading the screen display file and displaying the interactive screen includes reading a screen information file from the storage medium, searching for a screen aspect ratio directory having a screen aspect ratio predetermined for the reproducer according to the screen information file, reading a screen display file in the searched screen aspect ratio directory, and displaying an interactive screen based on the screen display file.

According to another aspect of the invention, the reading the screen display file and displaying the interactive screen includes searching the storage medium for the screen display file predetermined for the reproducer, and displaying the interactive screen based on the screen display file name.

According to yet another aspect of the invention, the reading the screen display file and displaying the interactive screen includes searching the storage medium for a screen mode directory predetermined for the reproducer, reading a screen display file in the searched screen mode directory, and displaying the interactive screen based on the screen mode directory.

According to still another aspect of the invention, the reading the screen display file and displaying the interactive screen includes reading the screen information file from the storage medium, searching the screen information file for the screen aspect ratio file having a screen aspect ratio predetermined for the reproducer, and displaying the interactive screen based on the screen aspect ratio file.

According to an additional aspect of the invention, the screen display files comprise files having display interactive information on a 4:3 screen, a 4:3 letter-box screen, and a 4:3 pan-scan screen, respectively.

According to a yet additional embodiment of the invention, a method of reproducing a storage medium including screen display files which realize interactive environments so as to be adjusted to various screen sizes, the method includes reading a display screen aspect ratio predetermined for a reproducer, searching for and reading one of the screen display files corresponding to the display screen aspect ratio, and displaying a screen based on the one screen display file, where each of the screen display files includes link tags linked to the others of the screen display files having the other screen aspect ratio modes so that a screen aspect ratio mode being displayed is changeable to another screen aspect ratio mode.

According to an aspect of the invention, the screen display files comprise files including corresponding display interactive information on a 4:3 screen, a 4:3 letter-box screen, and a 4:3 pan-scan screen, respectively.

### BRIEF DESCRIPTION OF THE DRAWINGS

The above and other object and advantages of the present invention will become more apparent and more readily appreciated by describing in detail embodiments thereof with reference to the accompanying drawings in which:

FIGS. 1A through 1D are views showing different kinds of screens that are displayable when reproducing a storage medium;

FIGS. 2A and 2B are views explaining an example of the distortion of a 4:3L screen when a storage medium having a HTML file being displayable on a 16:9W screen is displayed on the 4:3L screen;

FIGS. 3A through 3D are views of embodiments of different file structures of a storage medium that supports changes in a screen aspect ratio according to the present invention;

FIG. 4 is a flowchart of a method of reproducing the storage medium which supports the change of screen ratio according to an embodiment of the present invention;

FIGS. 5A and 5B are views showing that screen mode structure information (a navigation file, DVD_ENAV.IF0) provides directory path information of screen modes and indicates whether the screen modes are supported or not supported;

FIG. 6 is a flowchart of a method of reproducing the storage medium, having its structure shown in FIGS. 3A through 3B according to an embodiment of the present invention; and

FIG. 7 is a reproducer which reproduces the storage medium according to an embodiment of the present invention.

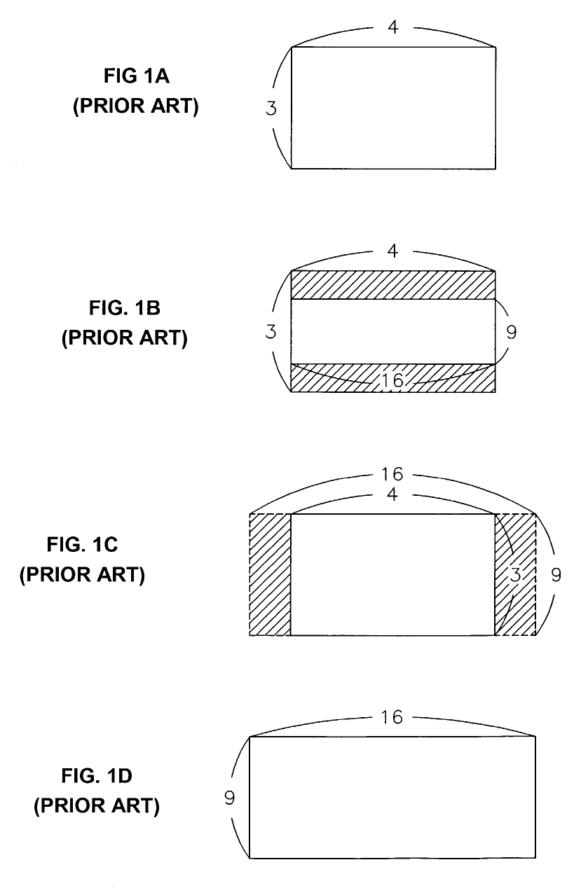

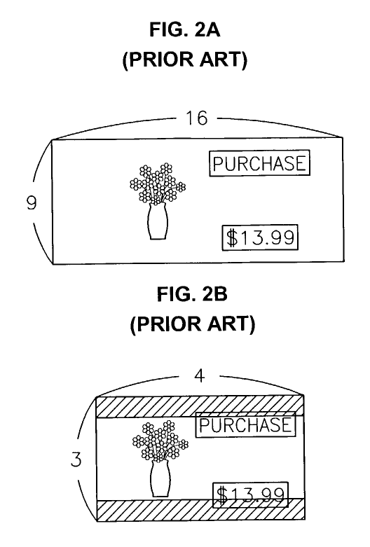

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

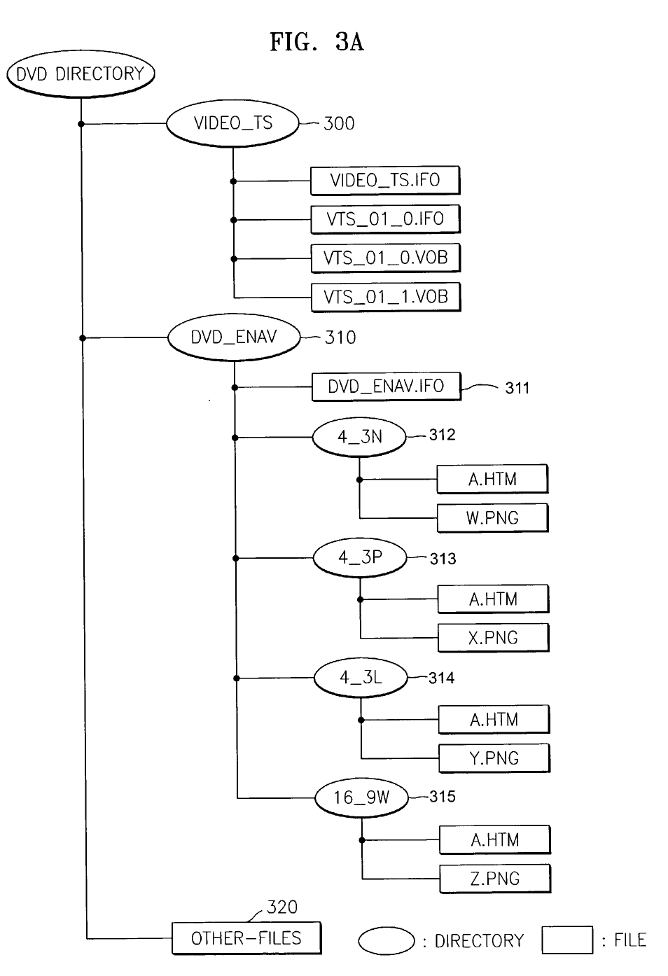

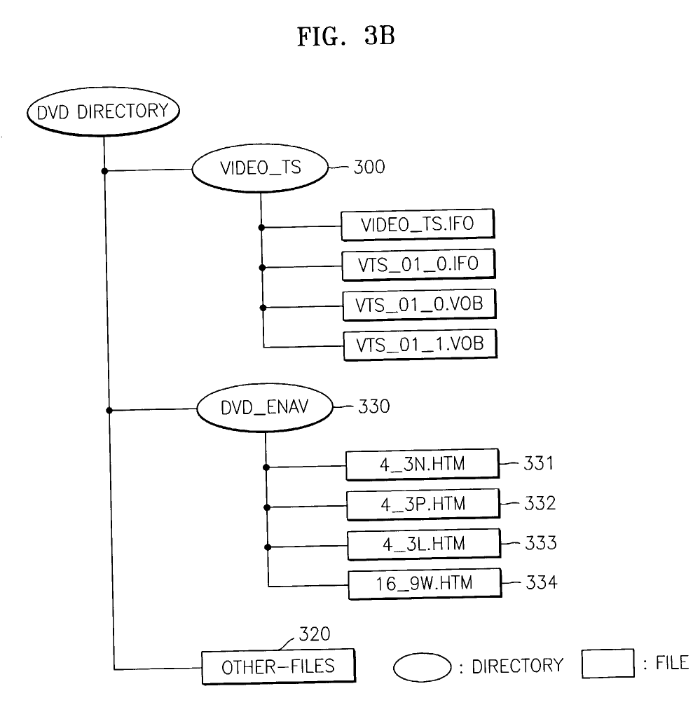

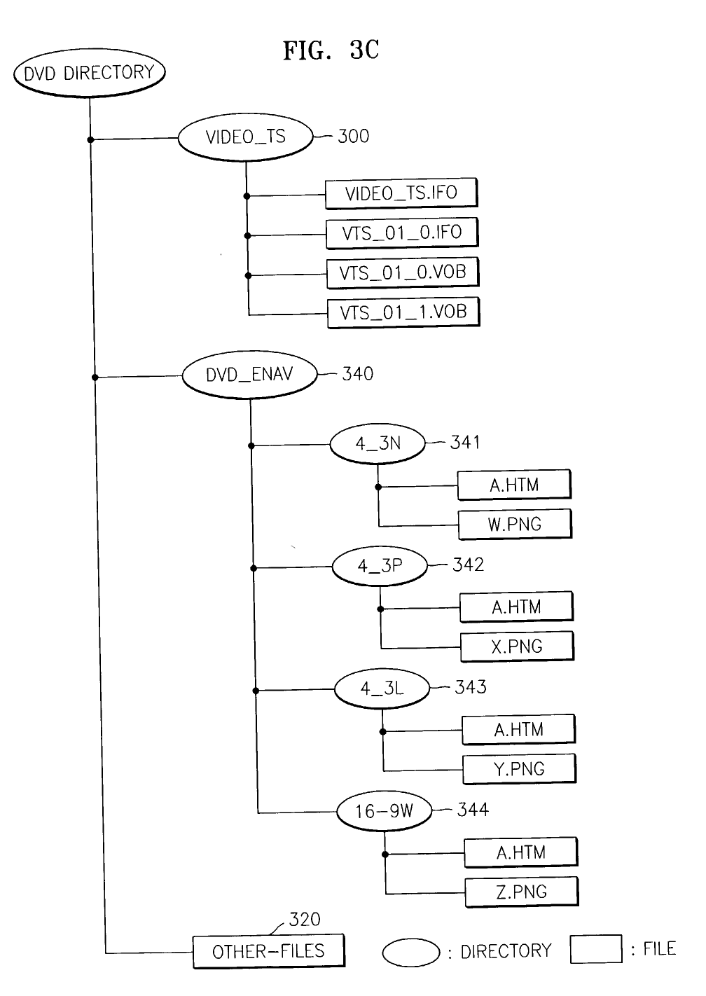

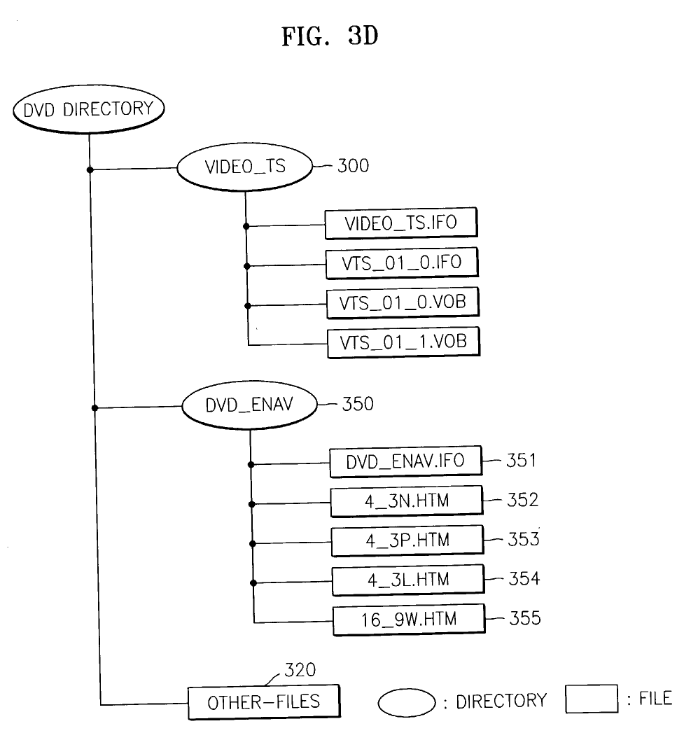

FIG. 3A is a view of an embodiment of a file structure of a storage medium that supports changes in a screen aspect ratio according to the present invention. In the embodiment shown in FIG. 3A, the storage medium has a directory structure for a digital versatile disc (DVD). The storage medium includes a video directory 300, an interactive directory 310, and other-files 320. The video directory 300 has video/audio contents related to screen display information and information files therefore. The interactive directory 310 includes files which are of markup language-based (such as hypertext markup language (HTML)) documents. The files enable the creation a user interactive screen, such as a browser screen. The other files 320 stores other information. While shown for a DVD and HTML documents, it is understood that other types of storage media could be used which includes information used to interact with a user and thus is not particularly limited to a DVD and/or HTML in particular.

The video directory 300 (which is represented by VIDEO_TS) includes a navigation file, which is a file that navigates a file necessary to reproduce the video/audio information, a video title set managing file, an video title menu file, an A/V contents file to be reproduced, and the like. The interactive directory 310, which is represented by a DVD_ENAV.IFO file 311, includes the files. Each of the files is a markup language-based (such as HTML) document and provides a user interactive function, an information search function via a network, and a website link function. Specifically, the interactive directory 310 includes a DVD_ENAV.IFO file 311 and various screen mode directories 312, 313, 314, 315. Each of the screen mode directories 312, 313, 314, 315 has a corresponding file that adjusts a picture to a corresponding one of multiple screens having a predetermined screen aspect ratio. The shown screen mode directories 312, 313, 314, 315 are a 4_{—}3N directory 312, a 4_{—}3P directory 313, a 4_{—}3L directory 314, an 16_{—}9W directory 315. However, it is understood that other directories having other screen aspect ratios can be used or will later be developed.

The 4_{—}3N directory 312 includes a file or files that adjusts an interactive screen to a general screen having a 4:3 screen aspect ratio. The 4_{—}3P directory 313 includes a file of files that adjusts a 16:9 interactive screen to a 4:3 screen by cutting unnecessary sides of the 16:9 interactive screen. The 4_{—}3L directory 314 includes a file or files that adjusts a 16:9 interactive picture to a 4:3 screen. The 16_{—}9W directory 315 includes a file or files that adjusts an interactive screen to a 16:9 screen.

As shown, the above-described screen mode directories 311, 312, 313, 314 respectively have files with the same screen display file name (i.e., A.HTM). Thus, when one screen mode needs to be changed to another screen mode, an interactive screen display file having the same file name can be found from the screen mode directory 311, 312, 313, 314 so as to simply change the display mode. Since the interactive file (A.HTM) in each screen mode directory 311, 312, 313, 314 includes other screen mode information, when the user selects the screen mode in an interactive screen having any screen mode, the present screen mode can be changed into the selected screen mode. However, it is understood that other naming conventions can be used which similarly allow a change of screen mode by accessing files in the other screen mode directories.

FIG. 3B is a view of another embodiment of the directory structure of the storage medium that supports changes in a screen aspect ratio. Referring to FIG. 3B, the storage medium (herein also shown as DVD as an example) has a directory structure. The storage medium includes a video directory 300, an interactive directory 330, and other-files 320. The video directory 300 has video/audio contents related to screen display information and information files therefore. The interactive directory 330 includes files 331, 332, 333, 334. Each of the files 331, 332, 333, 334 includes a markup language-based (such as hypertext markup language (HTML)) document and is able to create a user interactive screen, such as a browser screen. The other-files 320 store other information. The video directory 300 and the other-files 320 are the same as those described with reference to FIG. 3A, and thus only the interactive directory 330 will be described.

The interactive directory 330 (which is represented by DVD_ENAV) includes interactive screen mode files 311, 332, 333, 334 that adjust a picture to screens having different screen aspect ratios. These interactive screen mode files are shown as a 4_{—}3N.HTM file 331; a 4_{—}3P.HTM file 332, a 4_{—}3L.HTM file 333, and a 16_{—}9W.HTM file 334. The 4_{—}3N.HTM file 331 is a file that adjusts an interactive screen to a general screen having a 4:3 screen aspect ratio. The 4_{—}3P.HTM file 332 is a file that adjusts a 16:9 interactive screen to a 4:3 screen by cutting unnecessary sides of the 16:9 picture. The 4_{—}3L.HTM file 333 is a file that adjusts a 16:9 interactive picture to a 4:3 screen. The 16_{—}9W.HTM file 334 is a file that adjusts an interactive screen to a 16:9 screen.

According to an aspect of the invention, the above-described screen mode files 331, 332, 333, 334 each include link tag information therein that is linked to other screen mode files so that an aspect ratio of the interactive screen can be changed to another aspect ratio. For example, the 4_{—}3N.HTM file 331 has the following link tags therein.

<link rel=“aspect_ratio_{—}43P” src=“dvd://dvd_enav/4_{—}3P.HTM”>

<link rel=“aspect_ratio_{—}43L” src=“dvd://dvd_enav/4_{—}3L.HTM”>

<link rel=“aspect_ratio_{—}169W” src=“dvd://dvd_enav/16_{—}9W.HTM”>

As such, a user can change a 4:3N aspect ratio of an interactive screen constituted by the 4_{—}3N.HTM file 331 to a 4:3P, a 4:3L, or a 16:9W interactive screen mode by using the link tags. In other words, when the user selects “aspect_ratio_{—}169W” from the link tags, a current interactive screen mode can be recreated and displayed using the 16_{—}9W.HTM file.

When reproducing the storage medium having the directory structure shown in FIG. 3B, a reproducer selects one of the files 331, 332, 333, 334 in the interactive directory 330 of the storage medium according to a predetermined screen display file name to configure an interactive screen.

FIG. 3C is a view of a further embodiment of a directory structure of the storage medium that supports changes in a screen aspect ratio. Referring to FIG. 3C, the storage medium (shown by way of example as a DVD) has a directory structure. The storage medium includes a video directory 300, an interactive directory 340, and other-files 320. The video directory 300 has video/audio contents related to screen display information and information files therefore. The interactive directory 340 includes files. Each of the files is a markup language-based (such as hypertext markup language (HTML)) document and enables a creation of a user interactive screen, such as a browser screen. The other-files 320 store other information. The video directory 300 (which is represented by VIDEO_TS) and the other files 320 are the same as those described with reference to FIG. 3A, and thus their descriptions will be omitted.

The interactive directory 340 includes files (shown as A.HTM files) which are markup language-based (such as HTML) documents, and provide a user interactive function, an information search function via a network, and/or a website link function. The interactive directory 340 includes various screen mode directories 341, 342, 343, 344. Each of the screen mode directories 341, 342, 343, 344 includes a corresponding file that adjusts a picture to a screen having a corresponding one of multiple different screen aspect ratios. These screen mode directories are shown as a 4_{—}3N directory 341, a 4_{—}3P directory 342, a 4_{—}3L directory 343, and a 16_{—}9W directory 344. After the reproducer predetermines which one of the directories 341, 342, 343, 344 is to be used, the interactive directory 340 will be designated for use in the reproducer. Specifically, the reproducer searches the interactive directory 340 for a predetermined corresponding one of the directories 341, 342, 343, 344, searches for a predetermined start file (e.g., A.HTM) in the corresponding directory, and creates an interactive screen having the corresponding screen aspect ratio using the searched start file.

The 4_{—}3N directory 341 is a directory including a file or files that adjusts an interactive screen to a general screen having a 4:3 screen aspect ratio. The 4_{—}3P directory 342 is a directory including a file or files that adjusts a 16:9 interactive screen to a 4:3 screen by cutting unnecessary sides of the 16:9 picture. The 4_{—}3L directory 343 is a directory including a file or files that adjusts a 16:9 interactive picture to a 4:3 screen. The 16_{—}9W directory 344 is a directory including a file or files that adjusts an interactive screen to a 16:9 screen.

Each of the above-described screen mode directories 341, 342, 343, 344 has have a corresponding file with a common screen display file name (e.g., A.HTM). Thus, when one screen mode needs to be changed to another screen mode, an interactive screen display file having the same file name can be found from the another of the screen mode directories 341, 342, 343, 344 so as to simply change the display mode. Since the interactive file A.HTM in each screen mode directory 341, 342, 343, 344 includes other screen mode information, when the user selects another screen mode in an interactive screen having any screen mode, the user can move to the directory 341, 342, 343, 344 of the selected another screen mode.

FIG. 3D is a view of a further embodiment of the directory structure of the storage medium (shown by way of example as a DVD) that supports changes in a screen aspect ratio according to the present invention. Referring to FIG. 3D, the storage medium has a directory structure, which is represented by a digital versatile disc (DVD). The storage medium includes a video directory 300, an interactive directory 350, and other-files 320. The video directory 300 has video/audio contents related to screen display information and information files therefore. The interactive directory 350 includes files which are of markup language-based (such as hypertext markup language (HTML)) documents and enable to constitute a user interactive screen such as a browser screen. The other-files 320 store other information. The video directory 300 and the other-files 320 are the same as those described with reference to FIG. 3A, and thus only the interactive directory 350 will be described.

The interactive directory 350 includes a screen information file DVD_ENAV.IFO 351 and interactive screen mode files 352, 353, 354, 355 that adjust a picture to screens having different screen aspect ratios. These interactive screen mode files are a 4_{—}3N.HTM file 352, a 4_{—}3P.HTM file 353, a 4_{—}3L.HTM file 354, and a 16_{—}9W.HTM file 355.

The DVD_ENAV.IFO file 351 is first read when the reproducer reproduces an interactive screen and includes information on screen aspect ratios used when creating the interactive screen. The reproducer searches for a corresponding one of screen mode files 352, 353, 354, 355 based information on the screen aspect ratios in the DVD_ENAV.IFO 351. The 4_{—}3N.HTM file 352 is a file that adjusts an interactive screen to a general screen having a 4:3 screen aspect ratio. The 4_{—}3P.HTM file 353 is a file that adjusts a 16:9 interactive screen to a 4:3 screen by cutting unnecessary sides of the 16:9 picture. The 4_{—}3L.HTM file 354 is a file that adjusts a 16:9 interactive picture to a 4:3 screen. The 16_{—}9W.HTM file 355 is a file that adjusts an interactive screen to a 16:9 screen.

The above-described screen mode files 352, 353, 354, 355 include link tag information therein that is linked to other screen mode files so that an aspect ratio of the interactive screen can be changed to another aspect ratio. For example, the 4_{—}3N.HTM file 352 has the following link tags therein.

<link rel=“aspect_ratio_{—}43P” src=“dvd://dvd_enav/4_{—}3P.HTM”>

<link rel=“aspect_ratio_{—}43L” src=“dvd://dvd_enav/4_{—}3L.HTM”>

<link rel=“aspect_ratio_{—}169W” src=“dvd://dvd_enav/16_{—}9W.HTM”>

A user can change an interactive screen mode in an interactive screen created using the 4_{—}3N.HTM file 352 to a 4:3P, a 4:3L, or a 16:9W interactive screen mode by using the link tags. In other words, when the user selects “aspect_ratio_{—}169W” from the link tags, a current interactive screen mode is recreated using the 16_{—}9W.HTM file 355.

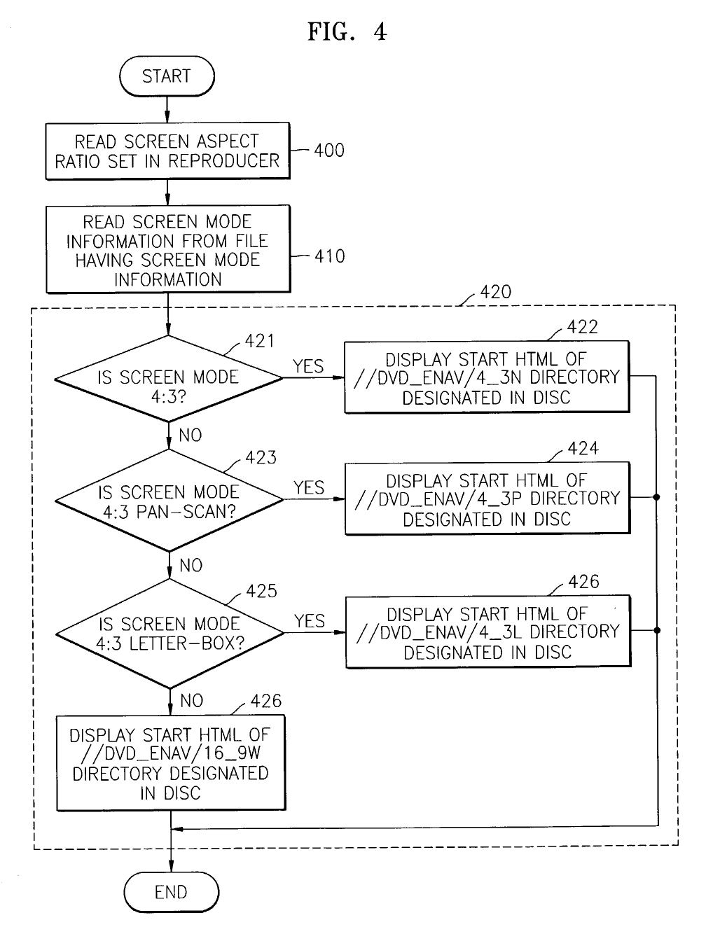

FIG. 4 is a flowchart of a method of reproducing the storage medium having the directory structure shown in FIGS. 3A or 3D. Referring to FIG. 4, in operation 400, when reproducing the storage medium, a reproducer reads a screen aspect ratio that is set in the reproducer. In operation 410, the reproducer reads screen mode information from the storage medium. In the embodiment of FIG. 3A, the reproducer searches directories having a screen aspect ratio (screen modes) designated in the file DVD_ENAV.IFO file 311 having screen mode configuration information from the storage medium and reads an interactive display file in the corresponding one of the directories 312, 313, 314, 315. In the embodiment of FIG. 3D, the reproducer searches files having the screen aspect ratios designated in the file DVD_ENAV.IFO file 351 including screen mode information and reads the corresponding one of the files 351, 352, 353, 354.

In operation 420, the reproducer displays an interactive screen based on the read interactive display file. While not required in all aspects of the invention, operation 420 includes sequential operations of searching screen modes. For example, in the embodiment of the storage medium having the directory structure shown in FIG. 3A, in operation 421, the reproducer determines whether a screen mode set in the reproducer is a 4:3 mode in order to display an interactive screen. If the screen mode is the 4:3 mode, in operation 422, a markup language document, which is designated in a //DVD_ENAV/4_{—}3N directory 312 as shown in FIG. 3A, is read from the storage medium and displayed on a screen. If the screen mode is not the 4:3 mode, the reproducer determines, in operation 423, whether the screen mode is a 4:3 pan-scan mode. If the screen mode is the 4:3 pan-scan mode, in operation 424, a markup language document, which is designated in a //DVD_ENAV/4_{—}3P directory 313, is read from the storage medium and displayed on the screen. If the screen mode is not the 4:3 pan-scan mode, the reproducer checks, in operation 425, whether the screen mode is a 4:3 letter-box mode. If the screen mode is the 4:3 letter-box mode, in operation 426, a markup language document, which is designated in a //DVD_ENAV/4_{—}3L directory 314, is read from the storage medium and displayed on the screen. If the screen mode is not the 4:3 letter-box mode, in operation 427, a markup language document, which is designated in a //DVD_ENAV/16_{—}9W 315 directory, is read from the storage medium and displayed on the screen.

In the flowchart shown in FIG. 4, the above operations may be repeated when a user selects another screen mode or an established screen mode in a reproducer is changed. Further, an operation of searching a corresponding mode from the storage medium and displaying a screen according to the corresponding mode may further be included, when the user changes the screen mode (aspect ratio) or the screen mode set in the reproducer is changed. The above-described screen mode information may include the directory path information of screen display files pertaining to the screen structure, or the information for indicating either support or no support of each mode as to the screen structure.

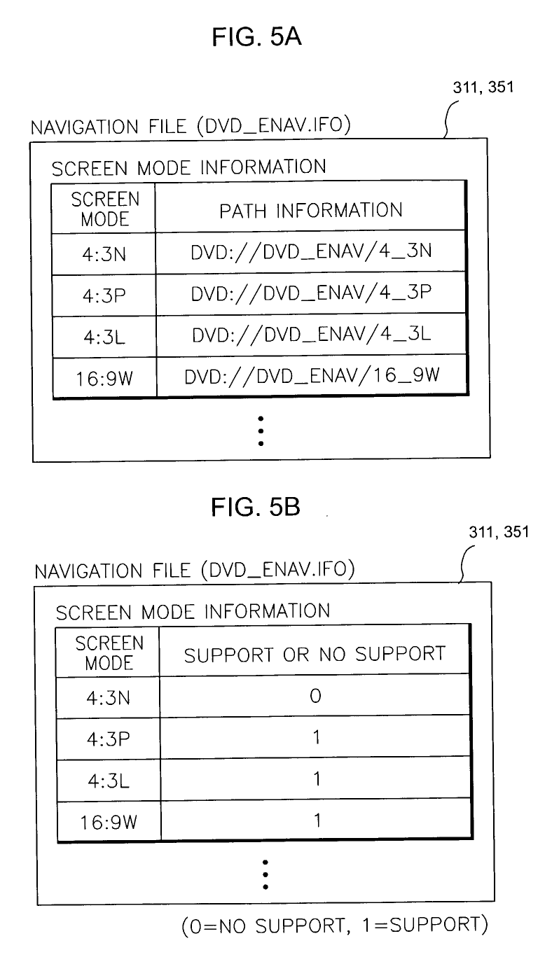

FIGS. 5A and 5B show embodiments in which screen mode information (a navigation file represented by DVD_ENAV.IFO file 311 in FIG. 3A and the DVD_ENAV.IFO file 351 shown in FIG. 3D) provides directory path information of screen modes and/or indicates whether the screen modes are supported or not supported.

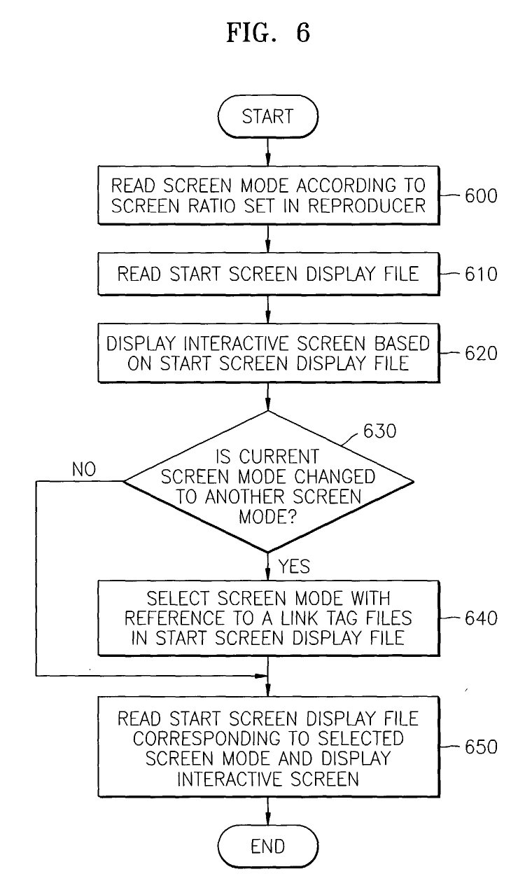

FIG. 6 is a flowchart of a method of reproducing the storage medium, having its structure shown in FIGS. 3A to 3D according to an additional embodiment of the present invention. In operation 600, a screen mode is read which is set by a user or in a reproducer. In operation 610, a start interactive screen display file is read which is suitable for the screen mode set in the reproducer. The start interactive screen display file is read from the storage medium. In the case of the storage medium having the directory structure shown in FIGS. 3A or 3D, the start interactive screen display file is selected from files designated in the DVD_ENAV.IFO file 311 of FIG. 3A or the DVD_ENAV.IFO file 351 of FIG. 3D.

For the storage medium having the structure shown in FIG. 3B, the start interactive screen display file 331, 332, 333, 334 that is read corresponds to a screen mode preset by the user or in the reproducer in operation 600. In other words, if the screen mode set by the user is a 4:3P mode, a 4_{—}3P.HTM file 332 corresponding to the 4:3P mode is read. For the storage medium having the structure shown in FIG. 3C, the start interactive screen display file is a screen display file in a directory 341, 342, 343, 344 corresponding to the screen mode preset by the user or in the reproducer in operation 600. In other words, if the screen mode set by the user is a 16:9W mode, a 16_{—}9W directory 344 corresponding to the 16:9W mode is selected, and thus a screen display file in the 16_{—}9W directory 344 is read.

In the embodiments of the storage medium having the directory structure shown in FIGS. 3A or 3D, the start interactive screen display file DVD_ENAV.IFO file 311 in FIG. 3A and the DVD_ENAV.IFO file 351 in FIG. 3D each includes the following link tag forms to be linked to another screen mode (source) files, with each file being used to create an interactive screen having a corresponding screen mode (screen aspect ratio).

<link rel=“aspect_ratio_{—}43N” src=“dvd://dvd_enav/4_{—}3N.HTM”>

<link rel=“aspect_ratio_{—}43P” src=“dvd://dvd_enav/4_{—}3P.HTM”>

<link rel=“aspect_ratio_{—}43L” src=“dvd://dvd_enav/4_{—}3L.HTM”>

<link rel=“aspect_ratio_{—}169W” src=“dvd://dvd_enav/16_{—}9W.HTM”>

In the embodiment of the storage medium having the directory structure shown in FIG. 3D, the screen mode (source) 4_{—}3N.HTM file 352, 4_{—}3P.HTM file 353, 4_{—}3P.HTM, 4_{—}3L.HTM file 354, and 16_{—}9W.HTM file 355 include link tags to be linked to the other screen mode source files 352, 353, 354, 355, so as to be changeable to another screen mode. As shown, the screen mode source files 352, 353, 354, 355 do not include a link tag to themselves. For example, the 4_{—}3N.HTM file 352 includes the following link tags so as to be changeable between a screen mode thereof and one of the other screen modes.

<link rel=“aspect_ratio_{—}43P” src=“dvd://dvd_enav/4_{—}3P.HTM”>

<link rel=“aspect_ratio_{—}43L” src=“dvd://dvd_enav/4_{—}3L.HTM”>

<link rel=“aspect_ratio_{—}169W” src=“dvd://dvd_enav/16_{—}9W.HTM”>

As in the storage medium having the directory structures shown in FIGS. 3B or 3C, the screen display files preset and searched in the reproducer include link tags to which paths of the other screen mode display source files are linked to change a screen mode to another screen mode.

In operation 620, an interactive screen is displayed based on the start screen display file read in operation 610. When changing a screen aspect ratio mode of the interactive screen to another screen aspect ratio mode in operation 630, a link tag is selected in the displayed interactive screen in operation 640 and a change to another screen mode is possible in operation 650.

A file (e.g., A.HTM) included in the 4:3 screen mode directory 311 of FIG. 3A will now be described.

```
<?xml version=“1.0”?>
<!DOCTYPE html
  PUBLIC “-//DVD//DTD XHTML DVD HTML 1.0//EN”
  “http://www.dvdforum/dvdenav/dvdhtml1-1-0.dtd”>
<html>
<head>
<title>DVD HTML sample</title>
<link rel=“ASPECT_RATIO_43”
src=“dvd://dvd_enav/4_3/a.htm”>
<link rel=“ASPECT_RATIO_43P”
src=“dvd://dvd_enav/4_3P/a. htm”>
<link rel=“ASPECT_RATIO_43L”
src=“dvd://dvd_enav/4_3l/a.htm”>
<link rel=“ASPECT_RATIO_169W”
src=“dvd://dvd_enav/16_9w/a.htm”>
.
.
.
</head>
<body>
<img src=“w.png” width=“401” height=“47” border=“0”/>
</body>
<html>
```

In the above example, the link tags are in an A.htm file, and each link tag has a screen mode name to be displayed and a pathname of a screen display file that is linked to the screen mode name.

In the above embodiment, all possible screen modes are displayed in the link tag form (i.e., as hypertext links) in one screen. In another embodiment, screen display files of each mode may include links to another screen mode display files. Thus, each of the screen modes can be changed into another screen mode.

According to the present invention, interactive information in a storage medium is adjusted to different screen aspect ratios. Thus, interactive information can be displayed without distorting the position and size thereof even when a screen of a predetermined size is changed into another screen of a different size. Also, the same interactive file name is used in each directory corresponding to each screen aspect ratio and a reference to another screen aspect ratio file is provided in each screen aspect ratio file, which results in an easy transition from one screen mode to another.

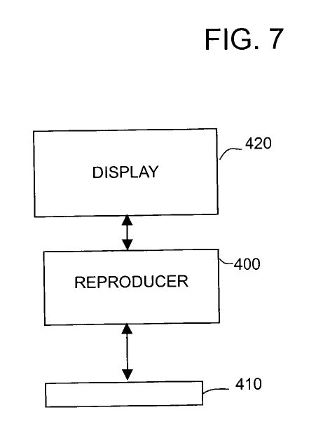

As shown in FIG. 7, a reproducer 400 is shown which reproduces a storage medium 410 which includes the contents and the interactive files corresponding to screens having different aspect ratios. The reproducer 400 reproduces the contents and the interactive files to be displayed in an interactive screen on a display 420. According to an aspect of the invention, the reproducer 400 is a DVD or other player or a computer which reproduces interactive information according to the methods shown in FIGS. 4 and/or 6. The storage medium 410 is a storage medium as shown in FIGS. 3A through 3D.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A storage medium providing various information that are displayable by a reproducer in a user interactive environment, the storage medium comprising:
audio and/or video contents to be displayed; and
interactive screen display files, each of the interactive screen display files referencing ones of the audio and/or video contents and corresponding to one of a plurality of different screen aspect ratios, respectively.

2. The storage medium of claim 1, wherein the interactive screen display files comprise files corresponding to screen aspect ratios for a 16:9 screen, a 4:3 screen, a 4:3 letter-box screen, and a 4:3 pan-scan screen.

3. The storage medium of claim 1, wherein the interactive screen display files comprise markup language-based document files.

4. A storage medium providing various information that are displayable by a reproducer in a user interactive environment, the storage medium comprising:
a screen information file which provides interactive screen information including displayable screen aspect ratio information;
audio and/or video contents to be displayed; and
directories, each directory respectively corresponding to one of a plurality of different screen aspect ratios that are designated in the screen information file, and a screen display file referencing ones of the audio and/or video contents and including data used to create an interactive screen in the one screen aspect ratio,
wherein, when reproducing the interactive screen information from the storage medium, one of the directories is searched which corresponds to one of the screen aspect ratios, the corresponding screen display file is read from the searched directory, and an interactive screen is created which is suitable for the corresponding one screen aspect ratio using the read screen display file.

5. The storage medium of claim 4, wherein the directories comprise directories corresponding to a 16:9 screen, a 4:3 screen, a 4:3 letter-box screen, and a 4:3 pan-scan screen, respectively.

6. The storage medium of claim 4, wherein the screen display files in the directories comprise markup language-based document files.

7. The storage medium of claim 4, wherein the screen display files in the directories have a common file name.

8. A storage medium providing various information that are displayable by a reproducer in a user interactive environment, the storage medium comprising:
audio/video contents to be displayed; and
screen aspect ratio files referencing the audio and/or video contents,
wherein:
one of the screen aspect ratio files is predetermined by the reproducer, and
the one screen aspect ratio file is searched for and read to create an interactive screen that is suitable for a screen aspect ratio corresponding to the searched one screen aspect ratio file.

9. The storage medium of claim 8, wherein the screen aspect ratio files comprise files corresponding to a 16:9 screen, a 4:3 screen, a 4:3 letter-box screen, and a 4:3 pan-scan screen, respectively.

10. The storage medium of claim 8, wherein the screen aspect ratio files comprise markup language-based document files.

11. The storage medium of claim 8, wherein each of the screen aspect ratio files include link tags linked to others of the screen aspect ratio files so that a screen aspect ratio mode being displayed is changeable to another screen aspect ratio mode.

12. A storage medium providing various information that are displayable by a reproducer in a user interactive environment, the storage medium comprising:
audio and/or video contents to be displayed; and
directories, each directory having a corresponding screen aspect ratio file which corresponds to a different one of a plurality of screen aspect ratios for a corresponding display in which an interactive screen displaying ones of the audio and/or video contents is to be displayed,
wherein, during reproduction, one of the directories having a screen aspect ratio predetermined in the reproducer is searched from the directories, a corresponding one of the screen display files is read from the searched directory, and the interactive screen is created having an aspect ratio corresponding to the read screen display file.

13. The storage medium of claim 12, wherein the directories correspond to a 16:9 screen, a 4:3 screen, a 4:3 letter-box screen, and a 4:3 pan-scan screen, respectively.

14. The storage medium of claim 12, wherein the screen display files comprise markup language-based document files.

15. The storage medium of claim 12, wherein the screen display files in the directories have a common file name.

16. A storage medium providing various information that are displayable in a user interactive environment, the storage medium comprising:
audio and/or video contents to be displayed;
a screen information file which provides interactive screen information including displayable screen aspect ratio information; and
files, each of the files referencing the audio and/or video contents having data on a corresponding one of a plurality of different screen aspect ratios included in the screen information file,
wherein, when reproducing the storage medium, one of the files is searched for which has been designated in the screen information file as corresponding to a screen aspect ratio to be display, an interactive screen is created suitable for the screen aspect ratio to be displayed, and the created interactive screen corresponds to the searched file.

17. The storage medium of claim 16, wherein the files comprise data corresponding to a 16:9 screen, a 4:3 screen, a 4:3 letter-box screen, and a 4:3 pan-scan screen, respectively.

18. The storage medium of claim 16, wherein the files comprise markup language-based document files.

19. The storage medium of claim 16, wherein each of the files include link tags linked to others of the files so that a screen aspect ratio mode being displayed is changed to another screen aspect ratio mode.

20. A method of reproducing a storage medium including screen display files which realize interactive environments so as to be adjusted to various screen sizes, the method comprising:
reading a display screen aspect ratio set in a reproducer; and
reading a screen display file having the display screen aspect ratio from the storage medium and displaying an interactive screen based on the read screen display file.

21. The method of claim 20, wherein the reading the screen display file comprises:
reading a screen information file from the storage medium;
searching a screen aspect ratio directory having the display screen aspect ratio based upon information in the screen information file; and
reading the screen display file in the searched screen aspect ratio directory and displaying the interactive screen based on the read screen display file.

22. The method of claim 20, wherein:
the reading the display screen aspect ratio set in the reproducer comprises reading a predetermined screen display file name set in the reproducer, and
the reading the screen display file comprises searching the storage medium for a screen display file having the predetermined screen display file name, and reading the searched screen display file from the storage medium.

23. The method of claim 20, wherein:
the reading the display screen aspect ratio set in the reproducer comprises reading a predetermined screen display directory name set in the reproducer, and
the reading the screen display file comprises searching the storage medium for a corresponding screen mode directory, and reading the screen display file in the searched screen mode directory.

24. The method of claim 20, wherein the reading the screen display file further comprises:
reading a screen information file from the storage medium; and
searching for the screen display file having the display screen aspect ratio as indicated in the read the screen information file, and reading the screen display file.

25. The method of claim 20, wherein the screen display files comprise files including display interactive information corresponding to a 4:3 screen, a 4:3 letter-box screen, and a 4:3 pan-scan screen.

26. A method of reproducing a storage medium including screen display files which realize interactive environments so as to be adjusted to various screen sizes, the method comprising:
reading a display screen aspect ratio set in a reproducer; and
searching for one of a plurality of screen display files corresponding to the display screen aspect ratio, reading the searched one screen display file, and displaying a screen based on the read one screen display file,
wherein each of the screen display files includes link tags linked to others of the screen display files having data corresponding other screen aspect ratio modes so that a screen aspect ratio mode being displayed is changeable to another screen aspect ratio mode.

27. The method of claim 26, wherein the screen display files comprise corresponding display interactive information on a 4:3 screen, a 4:3 letter-box screen, and a 4:3 pan-scan screen.

28. A storage medium readable by a reproducer to display information on a screen, the storage medium comprising:
contents to be displayed; and
screen files which reference the contents to be displayed in an interactive environment, each of the screen files having data use to display the interactive environment in a corresponding one of a plurality of different screen sizes.

29. The storage medium of claim 28, further comprising a screen information file which includes information as to a location of the screen files and the screen display sizes correspondingly associated with each of the screen files.

30. The storage medium of claim 28, wherein each of the screen files is in a corresponding directory.

31. The storage medium of claim 29, wherein each of the screen files is in a corresponding sub-directory, and the screen information file includes information as to a directory in which each of the screen files is located.

32. The storage medium of claim 28, wherein the contents comprise audio and/or video contents and are stored in a VIDEO_TS directory, the screen files are stored in another directory, and the storage medium further comprises other files stored in an other files directory.

33. The storage medium of claim 31, wherein the contents comprise audio and/or video contents and are stored in a VIDEO_TS directory, the screen files and the corresponding sub-directories are stored in an information directory, and the storage medium further comprises other files stored in an other files directory.

34. A reproducer to reproduce a storage medium, the reproducer comprising:
a reproducer unit which reproduces data from the storage medium, the data to be reproduced in an interactive environment; and
a display to display the reproduced data on a screen having a screen size,
wherein the reproducer unit:
selects from the storage medium one of a plurality of screen files stored on the storage medium, the selected one screen file including screen size data corresponding to the screen size, and
uses the selected one screen file to reproduce the data in the interactive environment.

35. The reproducer of claim 34, wherein the reproducer unit retrieves a screen aspect ratio for the display, associates one of the screen files with the retrieved screen aspect ratio, and uses the associated one screen file to reproduce the data in the interactive environment.

36. The reproducer of claim 34, wherein the reproducer unit reads a screen information file from the storage medium, searches a screen data directory corresponding to the screen size based upon information in the screen information file, and uses the screen file in the searched screen aspect ratio directory to reproduce the data in the interactive environment.

37. The reproducer of claim 34, wherein the reproducer unit retrieves a predetermined screen file name, searches the storage medium for a corresponding screen file having the predetermine screen file name, and uses the searched screen size file to reproduce the data in the interactive environment.

38. The reproducer of claim 34, wherein the reproducer unit retrieves a predetermined screen directory name, searches the storage medium for a corresponding screen directory having the predetermined screen directory name, and uses the screen file in the searched screen directory to reproduce the data in the interactive environment.

39. The reproducer of claim 34, wherein the reproducer unit receives a command to display the interactive environment using another screen size, searches for another of the screen files associated with the another screen size, and uses the another screen file to reproduce the data in the interactive environment.

40. A computer readable medium encoded with processing instructions for implementing a method of reproducing a storage medium to realize interactive environments adjusted to various screen sizes performed by a computer, the method comprising:
determining a screen size for an interactive screen to be displayed on a screen;
choosing a screen file having data for use in displaying the interactive screen for the determined screen size from other screen files having other data for use in displaying the interactive screen for other screen sizes;
reading the chosen screen file having the determined screen size from the storage medium; and
displaying the interactive screen with the determined screen size based on the read screen file.

41. The computer readable medium of claim 40, wherein the choosing and reading the screen file comprises:
reading a screen information file from the storage medium;
searching for a screen display directory having the screen file associated with the determined screen size based upon information in the screen information file; and
reading the screen file in the searched screen display directory.

42. The computer readable medium of claim 40, wherein:
the determining the screen size comprises reading a predetermined screen file name, and
the choosing and reading the screen file comprises searching the storage medium for a screen file having the predetermined screen file name, and reading the searched screen file from the storage medium.

43. The computer readable medium of claim 40, wherein:
the determining the screen size comprises reading a predetermined screen directory name, and
the choosing and reading the screen file comprises searching the storage medium for a screen directory corresponding to the predetermined screen directory name, and reading the screen display file in the searched screen directory.

44. The computer readable medium of claim 40, wherein the choosing and reading the screen file further comprises:
reading a screen information file from the storage medium, the screen information file having information relating screen files and corresponding screen sizes;
choosing and locating the screen file having the determined screen size as indicated in the read screen information file; and
reading the chosen and located screen display file.

45. The computer readable medium of claim 40, the method further comprising:
receiving input to display the interactive screen on one of the other screen sizes, and
searching for and choosing one of the other screen display files having data for use in displaying the interactive screen for the one other screen size, and
displaying the interactive screen on the one other screen size using the one other screen display file.
